(19) United States
(12) Patent Application Publication
(10) Pub. No.: US 2024/0120521 A1
(43) Pub. Date: Apr. 11, 2024

(54) Electrode Assembly, and Manufacturing Apparatus and Manufacturing Method Therefor

(71) Applicant: LG Energy Solution, Ltd., Seoul (KR)

(72) Inventor: Gyu Dae Ahn, Daejeon (KR)

(73) Assignee: LG Energy Solution, Ltd., Seoul (KR)

(21) Appl. No.: 18/273,425

(22) PCT Filed: Nov. 16, 2022
(86) PCT No.: PCT/KR2022/018062

§ 371 Date: Jul. 20, 2023

(30) Foreign Application Priority Data
Nov. 16, 2021 (KR) 10-2021-0157429
Nov. 15, 2022 (KR) 10-2022-0152709

(51) Int. Cl. H01M 10/04; B65G 47/46; H01M 50/105; H01M 50/403; H01M 50/46; H01M 50/463

(52) U.S. Cl. CPC H01M 10/0404; B65G 47/46; H01M 10/0468; H01M 50/105; H01M 50/403; H01M 50/46; H01M 50/463

(57) ABSTRACT

An electrode assembly manufacturing device according to the present disclosure includes a transfer unit for transferring an electrode assembly to a sealing position, multiple sealing blocks, and a lower support. The lower support is controlled to move up and down in a first state in which the sealing block is moved forward toward the electrode assembly, so that both distal ends of multiple separators in the longitudinal direction are bent downward and sealed while being in contact with the sealing block. Since the electrode assembly manufacturing device according to embodiments of the present invention heat-seals the end of the separator in a downwardly bent state, it is possible to manufacture an electrode assembly that prevents blocking of the separator when sealing a pouch.

### CROSS-REFERENCE TO RELATED APPLICATIONS

The present application is a national phase entry under 35 U.S.C. § 371 of International Application No. PCT/KR2022/018062 filed on Nov. 16, 2022, which claims the benefit of priority based on Korean Patent Application No. 10-2021-0157429 filed on Nov. 16, 2021 and Korean Patent Application No. 10-2022-0152709 filed on Nov. 15, 2022.

### TECHNICAL FIELD

An aspect of the present invention relates to an electrode assembly having a structure in which an end of a separator protruding from an electrode is heat-sealed in a state that is bent downward opposite to the stacking direction of the electrode assembly, and a manufacturing device and a manufacturing method thereof.

### BACKGROUND TECHNOLOGY OF THE INVENTION

In general, unlike a primary battery that cannot be charged, a secondary battery refers to a battery that can be charged and discharged, and such a secondary battery is widely used in the field of high-tech electronic devices such as phones, laptops, camcorders, etc.

The secondary battery is classified into a can-type secondary battery in which an electrode assembly is embedded in a metal can, and a pouch-type secondary battery in which an electrode assembly is embedded in a pouch-type battery case.

A pouch-type secondary battery includes an electrode assembly, an electrode lead coupled to the electrode assembly, and a pouch-type battery case accommodating the electrode assembly in a state in which the tip of the electrode lead is drawn out, and the electrode assembly has a structure in which the electrode and the separator are alternately stacked. Here, since the separator is cut to a size sufficient to cover the entire surface of the electrode, the separator protrudes from the end of the electrode assembly.

A pouch-type secondary battery is manufactured by accommodating an electrode assembly inside a pouch-type battery case and then sealing the battery case by pressurizing an area to be sealed at a high temperature using a sealing member. In addition, during the sealing process, a so-called separator wrinkling phenomenon may occur in which the separator protruding from the electrode assembly interferes with and adheres to the sealing area of the battery case.

A pouch-type battery case is usually a laminate sheet composed of an inner coating layer, a metal layer, and an outer coating layer, and by pressurizing an area to be sealed at a high temperature, the inner coating layer of the corresponding area is melted and the two layers of the battery case are heat-sealed. However, when the area to be sealed is pressurized at a high temperature, not only the inner coating layer of the battery case, but also the binder component of the separator melts together, so that the inner coating layer of the battery case and the separator can be sealed together, and this phenomenon is called a separator wrinkling.

In a secondary battery in which the separator wrinkling has occurred, when the secondary battery drifts for various reasons such as external physical impact, the internal electrode assembly drifts and the drifting force is transmitted to the inner coating layer of the battery case bonded to the electrode assembly, causing damage such as cracks to the inner coating layer, which then leads to insulation failure of the battery case.

In order to prevent such wrinkling of the separator, an attempt is made to heat-seal the end of the separator during the manufacturing step of the electrode assembly.

FIG. 1 shows a conventional method of heat-sealing the end of a separator.

Referring to FIG. 1, conventionally, when an electrode assembly 1 is transported to the sealing position by a conveyor 11, a pair of lower supports 13 located below both distal ends of the electrode assembly 1 in the longitudinal direction is raised and turned into a state in which both distal ends of the electrode assembly 1 are supported, and in this state, a sealing block 12 having a predetermined temperature moves forward toward the electrode assembly 1 in the direction of the arrow and heat-seals the separator by heating the end of the separator S of the electrode assembly. However, as shown in FIG. 1, when the end of the separator is heat-sealed in this process, part of the separator is heat-sealed in an upwardly bent state, and the other part is heat-sealed in a downwardly bent state.

When the downward and upward directions of bending of the separator are present, part of the separator is unfolded again according to the bending direction during the sealing process of the battery case, causing the separator to wrinkle.

### DESCRIPTION OF THE INVENTION

### Technical Problem

In order to solve such a conventional problem, the present technology is directed to provide an electrode assembly, a manufacturing device, and a manufacturing method thereof, in which wrinkling of a separator is prevented during sealing of a battery case by controlling the heat-sealing direction of the separator in a downward direction.

### Technical Solution

The electrode assembly manufacturing device according to an exemplary embodiment of the present invention includes: a transfer unit for transferring an electrode assembly, in which multiple electrodes and separators are alternately stacked, to a sealing position; multiple sealing blocks configured to be able to move forward toward the electrode assembly transferred to the sealing position, and seal the ends of multiple separators by heating and pressing; and a pair of lower supports located below both distal ends of the electrode assembly in the longitudinal direction, and supporting both distal ends of the electrode assembly in the longitudinal direction by moving up to seal the separator; and a control unit for controlling the operation of the transfer unit, the sealing block, and the lower support. The control unit controls the lower support to be moved up in a first state in which the sealing block is moved forward toward the electrode assembly, and as the lower support moves up, both distal ends of multiple separators in the longitudinal direction are bent downward and sealed while contacting the sealing block. The control unit controls the lower support to be moved down after the first state.

In the electrode assembly manufacturing device according to an exemplary embodiment of the present invention, the first state may be a state in which multiple sealing blocks are mutually moved forward so that the distance between the sealing block located on one side and the sealing block located on the other side is smaller than the length of the separator in the longitudinal direction and greater than the length of the electrode in the longitudinal direction, with respect to the longitudinal direction of the electrode assembly.

In the electrode assembly manufacturing device according to an exemplary embodiment of the present invention, the transfer unit may include a conveyor on which the electrode assembly is disposed, and the conveyor may be configured to transfer the electrode assembly in a state in which the electrode assembly is disposed so that the longitudinal direction of the electrode assembly perpendicularly intersects the transferring direction of the conveyor.

In the electrode assembly manufacturing device according to an exemplary embodiment of the present invention, the width of the conveyor may be smaller than the length of the electrode assembly in the longitudinal direction, so that the electrode assembly disposed on the conveyor is bent along the longitudinal direction, thereby both distal ends in the longitudinal direction are located below the height of the contact surface between the conveyor and the electrode assembly.

In the electrode assembly manufacturing device according to an exemplary embodiment of the present invention, each of the multiple sealing blocks may have a “¬” shape corresponding to the shape of the corner part of the electrode assembly.

In the electrode assembly manufacturing device according to an exemplary embodiment of the present invention, each of the multiple sealing blocks may have a curved surface shape in contact with the corner part of the electrode assembly.

In the electrode assembly manufacturing device according to an exemplary embodiment of the present invention, the multiple sealing blocks may be composed of four sealing blocks.

The electrode assembly manufacturing device according to an exemplary embodiment of the present invention may further comprises a pair of alignment blocks for aligning the electrode assembly, and wherein the pair of alignment blocks is disposed on the transfer unit and is spaced apart from each other by a distance corresponding to the length of the electrode assembly in the width direction, and the electrode assembly may be placed within the spacing between the alignment block.

In the electrode assembly manufacturing device according to an exemplary embodiment of the present invention, the alignment block may have a bar or cuboid shape and extends along the longitudinal direction of the electrode assembly.

The electrode assembly manufacturing method according to an exemplary embodiment of the present invention includes: (a) a transferring step of transferring the electrode assembly, in which multiple electrodes and separators are alternately stacked, to the sealing position; (b) a first step in which a sealing block located on one side of the electrode assembly in the longitudinal direction and a sealing block located on the other side of the electrode assembly in the longitudinal direction are moved forward in the direction of the mutual electrode assembly at predetermined distance; and (c) a second step in which as both distal ends in the longitudinal direction of the electrode assembly are raised by the support that moves up and down toward the electrode assembly from the lower part of electrode assembly, the separator at both distal ends is bent downward and sealed while contacting the multiple sealing blocks.

In the electrode assembly manufacturing method according to an exemplary embodiment of the present invention, the predetermined distance in the first step of (b) may be smaller than the length of the separator in the longitudinal direction and greater than the length of the electrode in the longitudinal direction.

In the electrode assembly manufacturing method according to an exemplary embodiment of the present invention, the transferring step (a) may transfer the electrode assembly to the sealing position while being disposed on the conveyor.

In the electrode assembly manufacturing method according to an exemplary embodiment of the present invention, the second step (c) may have the support moving up and down in a state in which the multiple sealing blocks are moved forward at a predetermined distance by the first step (b).

In the electrode assembly manufacturing method according to an exemplary embodiment of the present invention, the second step of (c) may have the sealing blocks heat the separator in contact with the sealing blocks to a predetermined temperature so that the binder component of the separator is melted, thereby forming an adhesive strength.

In the electrode assembly manufacturing method according to an exemplary embodiment of the present invention, there may be an additional alignment step of aligning the electrode assembly between the transferring step (a) and the first step (b).

In the electrode assembly manufacturing method according to an exemplary embodiment of the present invention, after the second step (c), it may further include: a step of moving back the multiple sealing blocks that have moved forward in the first step to their original positions; a step of lowering the lower support, which has moved upward in the second step, to its original position; and a step of taking the electrode assembly sealed with the separator out from the sealing position.

According to an aspect of the present invention, an electrode assembly in which multiple electrodes and separators are alternately stacked is provided, wherein a separator protruding from an end of the electrode has its distal end bent downward opposite to the stacking direction.

In addition, according to an aspect of the present invention, a pouch-type secondary battery characterized by having an electrode assembly accommodated in the accommodating unit of the pouch-type battery case is provided, and the electrode assembly has a structure in which multiple electrodes and separators are alternately stacked, the separator protruding from the end of the electrode is in a state in which its end is bent in the first direction, and the accommodating part of the pouch-type battery case protrudes on a plane, and protrudes in a direction opposite to the first direction.

### Advantageous Effects

Since the electrode assembly manufacturing device and manufacturing method according to the present disclosure heat-seal the end of the separator in a downwardly bent state, it is possible to manufacture an electrode assembly and a lithium secondary battery in which the separator is prevented from wrinkling when sealing a pouch-type battery case.

### BRIEF DESCRIPTION OF THE DRAWINGS

FIG. 1 is a diagram for explaining problems of a conventional manufacturing method of an electrode assembly.

FIG. 2 is a perspective view of an electrode assembly manufacturing device according to an exemplary embodiment of the present invention.

FIG. 3 is a top view of an electrode assembly manufacturing device according to an exemplary embodiment of the present invention.

FIG. 4 is a conceptual diagram for explaining the effect according to the operation sequence of a sealing block and a lower support.

FIG. 5 is a perspective view of a sealing block according to an exemplary embodiment of the present invention.

FIG. 6 is a perspective view of a sealing block according to another exemplary embodiment of the present invention.

FIG. 7 is a diagram illustrating a pouch-type secondary battery according to an exemplary embodiment of the present invention.

FIG. 8 is a cross-sectional view taken along line A-A′ of FIG. 7.

FIG. 9 is an enlarged view of a part of FIG. 8.

FIG. 10 is a diagram showing a process of accommodating an electrode assembly in a battery case and sealing the battery case during the manufacturing process of a pouch-type secondary battery according to an exemplary embodiment of the present invention.

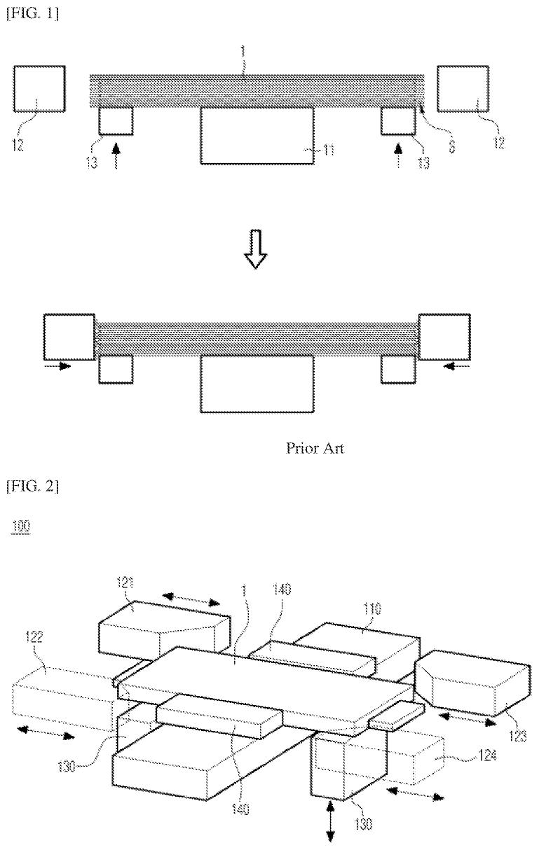

### REFERENCE NUMERALS

1: ELECTRODE ASSEMBLY
10, 100: ELECTRODE ASSEMBLY MANUFACTURING DEVICE
11, 110: TRANSFER UNIT
12, 120, 121˜124, 220: SEALING BLOCK
13, 130: LOWER SUPPORT
140: ALIGNMENT BLOCK

### DETAILED DESCRIPTION

The present invention may have various modifications and various examples, and thus specific examples are illustrated in the drawings and described in detail in the description. However, it should be understood that the present invention is not limited to specific embodiments, and includes all modifications, equivalents or alternatives within the spirit and technical scope of the present invention.

The terms “comprise,” “include” and “have” used herein to designate the presence of characteristics, numbers, steps, actions, components or members described in the specification or a combination thereof, and it should be understood that the possibility of the presence or addition of one or more other characteristics, numbers, steps, actions, components, members or a combination thereof is not excluded in advance. In addition, when a part of a layer, a film, a region or a plate is disposed “on” another part, this includes not only a case in which one part is disposed “directly on” another part, but a case in which a third part is interposed therebetween. In contrast, when a part of a layer, a film, a region or a plate is disposed “under” another part, this includes not only a case in which one part is disposed “directly under” another part, but a case in which a third part is interposed therebetween. In addition, in this application, “on” may include not only a case of disposed on an upper part but also a case of disposed on a lower part.

In the present specification, the X-axis direction corresponds to the longitudinal direction of the electrode assembly and the width direction of the conveyor, the Y-axis direction corresponds to the width direction of the electrode assembly and the transferring direction of the conveyor, and the Z-axis direction corresponds to the up-and-down movement direction of the lower support.

Hereinafter, the electrode assembly manufacturing device of embodiments of the present invention will be described in detail.

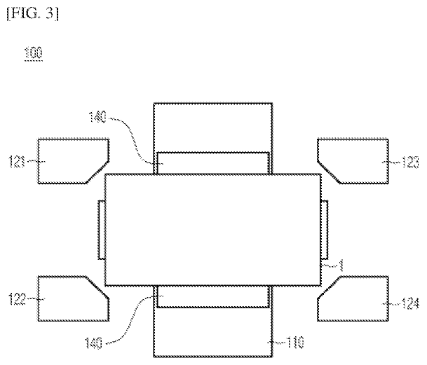

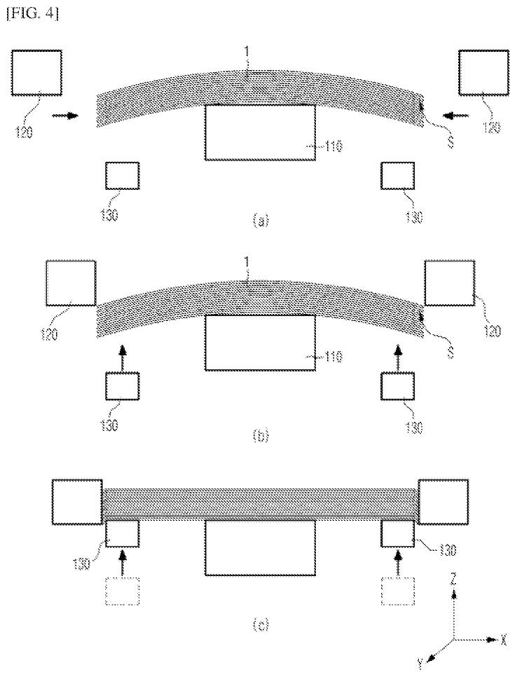

FIG. 2 is a perspective view of an electrode assembly manufacturing device according to an exemplary embodiment of the present invention, FIG. 3 is a top view of an electrode assembly manufacturing device according to an exemplary embodiment of the present invention, and FIG. 4 is a conceptual diagram for explaining the effect according to the operation sequence of the sealing block and the lower support.

Referring to these diagrams, the electrode assembly manufacturing device 100 according to an exemplary embodiment of the present invention includes: a transfer unit 110 for transferring an electrode assembly 1, in which multiple electrodes and separators are alternately stacked, to a sealing position; multiple sealing blocks 120; 121-124 configured to be able to move forward toward the electrode assembly 1 transferred to the sealing position, and seal the ends of multiple separators by heating and pressing; and a pair of lower supports 130 located below both distal ends of the electrode assembly in the longitudinal direction (X-axis direction), and supporting both distal ends of the electrode assembly in the longitudinal direction by moving up and down to seal the separator; and a control unit (not illustrated) for controlling the operation of the transfer unit 110, the sealing block 120, and the lower support 130.

The control unit controls the lower supports 130 to be moved up in a first state in which the sealing block 120 is moved forward toward the electrode assembly 1, and as the lower support 130 moves up, both distal ends of multiple separators in the longitudinal direction are bent downward and heat-sealed while contacting the sealing block 120.

Here, the first state refers to a state in which the multiple sealing blocks 120; 121˜124 are in close proximity to the electrode assembly so as to be able to come into contact with the ends of the separator at both distal ends in the longitudinal direction of the electrode assembly.

Referring to FIG. 4, a process in which the end of the separator is heat-sealed by the electrode assembly manufacturing device according to an embodiment of the present invention will be described. Typically, since the length of the separator S within the electrode assembly 1 in the longitudinal direction (X-axis direction) is longer than the length of the electrode in the longitudinal direction, the distal end of the separator protrudes beyond the distal end of the electrode. The electrode assembly manufacturing device according to an embodiment of the present invention is for heat-sealing the distal end of the protruding separator S to a state of being bent in one direction.

Part (a) of FIG. 4 shows a state in which the electrode assembly 1 is transferred to the sealing position by the transfer unit 110. At this time, the width (X-axis direction) of the means (e.g., a conveyor) on which the electrode assembly 1 is placed in the transfer unit 110 may be configured to be smaller than the length in the longitudinal direction (X-axis direction) of the electrode assembly. Accordingly, the central part of the electrode assembly is supported by the disposition means of the transfer unit 110, but the corner part on both sides of the electrode assembly located outside the disposition means of the transfer unit 110 does not have means of support, so it may be gently curved in a shape of an arch along the longitudinal direction (X-axis direction) due to the weight of the electrode assembly itself.

When the electrode assembly 1 is transferred to the sealing position, the control unit 140 controls the sealing block 120 to move forward toward the electrode assembly 1, so that the electrode assembly manufacturing device 100 turns into the first state as shown in part (b) of FIG. 4. In the first state, the distance between the sealing blocks 120 may be set to be smaller than the length of the separator in the longitudinal direction and greater than the length of the electrode in the longitudinal direction.

In the first state, the control unit 140 controls the lower support 130 located below the electrode assembly 1 to move up. As the lower support 130 moves up, the electrode assembly 1 that has been bent in a shape of an arch gradually straightens, and both distal ends of the separator come into contact with the sealing block 120 and bends downward, which is the opposite direction to the up direction of the lower support 130, and is heated and pressed by the high-temperature sealing block 120 as both distal ends of the separator are heat-sealed in a downwardly bent state, as shown in part (c) of FIG. 4.

As such, the electrode assembly manufactured by the electrode assembly manufacturing device of the embodiments of present invention is heat-sealed in a state in which the bending direction of the distal end of the separator is uniformly bent downward. In addition, the electrode assembly heat-sealed with the distal end of the separator bent downward has an effect of preventing the separator from being wrinkled. This will be described later with reference to FIG. 10.

The transfer unit 110 may include a conveyor on which the electrode assembly 1 is placed, and it may further include a transfer unit controller (not illustrated) that stops the transferring operation of the conveyor by the driving unit when the driving unit (not illustrated) that moves the conveyor in the transferring direction and the electrode assembly placed on the conveyor are transferred to a sealing position, and resumes the transferring operation of the conveyor once the sealing of the separator of the electrode assembly is completed.

In placing the electrode assembly on the conveyor, the electrode assembly is placed on the conveyor such that the longitudinal direction of the electrode assembly perpendicularly intersects the transferring direction of the conveyor (Y-axis direction in FIG. 3). The length in the longitudinal direction of the electrode assembly placed in this way is longer than the width (X-axis direction in FIG. 3) of the conveyor.

In the embodiments of present invention, the width of the conveyor is smaller than the length of the electrode assembly in the longitudinal direction, so that the electrode assembly does not form a straight line along the longitudinal direction and is gently bent, as shown in parts (a) & (b) of FIG. 4. And both distal ends in the longitudinal direction of the electrode assembly, which are not supported by the conveyor, are naturally located below the height of the contact surface between the conveyor and the electrode assembly due to the weight of the electrode assembly.

Accordingly, since both distal ends of the electrode assembly in the longitudinal direction are positioned below the sealing block, even if the sealing block moves forward toward the electrode assembly for sealing and turns into the first state, both distal ends of the electrode assembly in the longitudinal direction maintain a non-contact state with the sealing block and is located below the sealing block.

The first state is a state in which multiple sealing blocks are in close proximity to the electrode assembly so as to be able to contact the separator protrusions at both distal ends of the electrode assembly in the longitudinal direction. In one specific example, the first state is a state in which sealing blocks are mutually moved forward so that the distance between the sealing block located on one side and the sealing block located on the other side is smaller than the length of the separator in the longitudinal direction and greater than the length of the electrode in the longitudinal direction, with respect to the longitudinal direction of the electrode assembly.

In the first state as described above, when the lower support located below the electrode assembly moves upward, both distal ends of the electrode assembly rise in a state supported by the support, and the separators at both distal ends come into contact with the sealing block. Here, the length of the separator between the sealing block on one side and the sealing block on the other side in the longitudinal direction is greater than the distance between the sealing blocks, and since both distal ends of the electrode assembly are in a state of being gently bent by the load, as shown in FIG. 4, while both distal ends of the electrode assembly are raised, the separator in contact with the sealing block is naturally bent downward and sealed.

The multiple sealing blocks 120 are for heat-sealing both distal ends of multiple separators in the longitudinal direction, and are provided on one side 121, 122 and the other side 123, 124 of the electrode assembly in the longitudinal direction, respectively. FIG. 2 and FIG. 3 illustrate an embodiment in which the sealing block is composed of four sealing blocks, two of which are located on one side and two on the other side in the longitudinal direction of the electrode assembly, but is not limited thereto.

The sealing blocks 121, 122 provided on one side and the sealing blocks 123, 124 provided on the other side are configured to be able to move forward toward the electrode assembly or move backward in the opposite direction so as to be in the first state, which is an appropriate position for sealing the separator.

Multiple sealing blocks have a predetermined temperature, and accordingly, the sealing blocks heat and press both distal ends of the separator in the longitudinal direction, thereby effectively bending and heat-sealing the distal end of the separator.

In one specific example, each of the multiple sealing blocks may have a coating layer formed so that the pressing surface is not stained with the binder component of the separator, and the coating layer may be made of silicon (Si) or Teflon. Accordingly, the sealing block can save the trouble of cleaning the pressing surface every time.

Meanwhile, the multiple sealing blocks may further include a position adjusting unit (not illustrated) for adjusting the position so that the electrode assembly is disposed at the center of the sealing block on one side and the sealing block on the other side, and when the electrode assembly is transferred to the sealing position, the position adjusting unit photographs the electrode assembly and the sealing block from the top, checks the center line of the press block and the center line of the electrode assembly in the photographed image, and may allow the sealing block to move forward or backward in the direction of the arrow in FIG. 2 in order to match the center lines.

FIG. 5 shows the shape of a sealing block according to an exemplary embodiment. Referring to FIG. 5, each of the multiple sealing blocks may have a “¬” shape corresponding to the shape of a corner part of the electrode assembly. The corner part refers to a part around the vertex of the electrode assembly in the longitudinal direction, and as the sealing block has an “L” shape, the separator protruding from the electrode can be effectively bent and sealed.

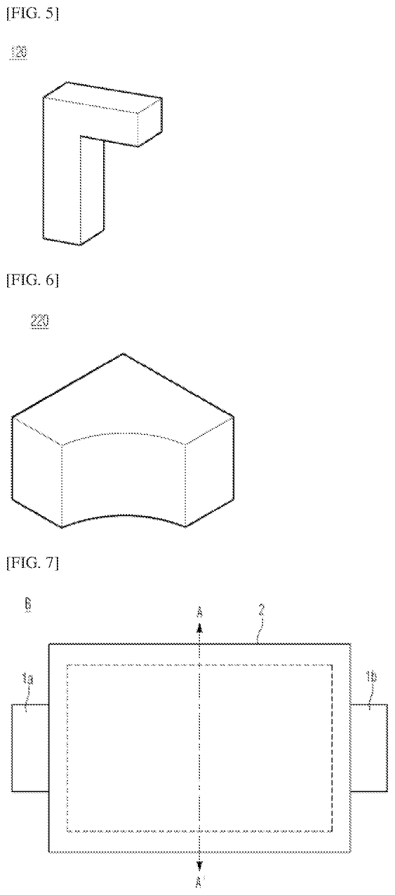

FIG. 6 shows the shape of a sealing block according to another exemplary embodiment. Referring to FIG. 6, each of the multiple sealing blocks has a curved surface shape in contact with the corner part of the electrode assembly. Accordingly, when heating and pressing by the sealing block, damage to the separation membrane can be prevented.

The lower supports 130 are for bending the separator, and the lower supports may be configured as a pair to support both distal ends of the electrode assembly in the longitudinal direction.

The lower support 130 is controlled to be moved upward to support both distal ends of the electrode assembly in the longitudinal direction after the sealing block moves to the first state in order to bend the separator downward.

In one specific example, the electrode assembly manufacturing device 100 of an embodiment of the present invention may further include a pair of alignment blocks 140 for aligning the electrode assembly 1. The alignment block 140 guides some of the electrodes or some separators that are arranged out of alignment with the alignment direction of the electrode assembly 1 to be properly aligned. Accordingly, the height of the alignment block may correspond to the total thickness of the electrode assembly or may be slightly higher than the total thickness of the electrode assembly.

Referring to FIG. 2 and FIG. 3, the pair of alignment blocks 140 may have a bar shape, or may extend along the entire longitudinal direction (X-axis direction) of the electrode assembly 1.

Also, in one specific example, the pair of alignment blocks 140 are disposed on the transfer unit 110, and are spaced apart by a distance corresponding to the width of the electrode assembly 1 (Y-axis direction).

Hereinafter, the electrode assembly manufacturing method of the embodiments of present invention will be described in detail.

As illustrated in FIG. 2 to FIG. 4, The electrode assembly manufacturing method according to an exemplary embodiment of the present invention includes: (a) a transferring step of transferring the electrode assembly, in which multiple electrodes and separators are alternately stacked, to the sealing position; (b) a first step in which a sealing block located on one side of the electrode assembly in the longitudinal direction and a sealing block located on the other side of the electrode assembly in the longitudinal direction are moved forward in the direction of the mutual electrode assembly at predetermined distance; and (c) a second step in which as both distal ends in the longitudinal direction of the electrode assembly are raised by the support that moves up toward the electrode assembly, the separator at both distal ends is bent downward and sealed while contacting the multiple sealing blocks.

The step (a) is a step of transferring the electrode assembly 1 in a state in which multiple electrodes and separators are alternately stacked to a sealing position suitable for sealing by multiple sealing blocks 120; 121˜124 and a pair of supports.

In one specific example, in the step (a) of transferring, the electrode assembly may be transferred to a sealing position in a state in which the electrode assembly is placed on a conveyor.

In addition, the width of the conveyor is adjusted to be smaller than the length of the electrode assembly in the longitudinal direction of the electrode assembly, so that both distal ends are located below the height of the conveyor by being bent downward along the longitudinal direction of the electrode assembly by its own load.

The step (b) is a step of moving the sealing blocks 120; 121˜124 located on both sides of the electrode assembly forward in the direction of the electrode assembly at a predetermined distance so that the distance between one another is narrowed.

The predetermined distance means a distance between sealing blocks that contact the separator to heat and press the separator, but do not contact the electrode, and specifically, it can be a distance smaller than the separator in the longitudinal direction and greater than the electrode in the longitudinal direction. Accordingly, multiple sealing blocks can stably press and bend both distal ends of the separator in the longitudinal direction, and since both distal ends of the electrode in the longitudinal direction are not pressed, deformation of the electrode can be prevented.

Meanwhile, between the transfer step (a) and the first step (b), an alignment step of aligning the electrode assembly may be further included. Some of the electrodes or separators constituting the electrode assembly may be misaligned with the alignment direction of the electrode assembly, and through the alignment step, misaligned electrodes or separators can be correctly aligned, thereby preventing separator sealing failure.

The second step (c) allows the support to move up in a state in which multiple sealing blocks are moved forward at a predetermined distance by the first step (b), so that both distal ends of the separator come into contact with the sealing blocks.

That is, in a state in which multiple sealing blocks are moved toward the electrode assembly at a predetermined distance, the separator having a length longer than the distance between multiple sealing blocks comes into contact with the sealing block by the upward movement of the lower support that rises as it supports both distal ends of the electrode assembly. And both distal ends of the separator are in contact with the fixed sealing block during contact, so that both distal ends of the separator are bent downward, and the separators are sealed (adhered) to each other.

In the second step (c), as the sealing block has a set temperature, both distal ends in the longitudinal direction of the separator in contact with the sealing block are heated, thereby adhesive strength is formed by melting the binder component of the coating layer applied to both distal ends of the separator.

Here, the set temperature may be 60° C. to 90° C. If the set temperature is less than 60° C., it is difficult to melt the coating layer applied to the separator, conversely, if the set temperature exceeds 90° C., the separator may shrink and deform, which is not desirable.

As described above, after sealing the separators at both distal ends of the electrode assembly by the operation of the sealing block and the lower support, a step of moving back the multiple sealing blocks that have moved forward in the first step (b) to their original positions; a step of lowering the lower supports, which has moved upward in the second step (c), to its original position: and a step of taking the electrode assembly sealed with the separator out from the sealing position may be sequentially performed.

As such, in the electrode assembly manufacturing method according to the embodiments of present invention, as the lower supports rise they support both distal ends of the electrode assembly in a state in which the sealing blocks sealing the separators at both distal ends of the electrode assembly in the longitudinal direction are moved forward at a predetermined distance, the separators at both distal ends are sealed in a downwardly bent state as they come into contact with the sealing block, thereby an electrode assembly in which wrinkling of the separator is prevented during a pouch sealing can be manufactured.

Hereinafter, the electrode assembly according to embodiments of the present invention will be described in detail.

The electrode assembly according to embodiments of the present invention has a structure in which multiple electrodes and multiple separators are alternately stacked.

Here, the electrode may be a cathode or an anode, and the separator has a larger area than that of the electrode in order to prevent a short circuit between the cathode and the anode. In other words, both distal ends of the of the electrode assembly in the longitudinal direction and both distal ends of the electrode assembly in the width direction protrude beyond both distal ends of the electrode in the longitudinal direction and both distal ends of the electrode in the width direction, respectively, so that it can prevent a short circuit.

Particularly, multiple separators protruding from both distal ends of the electrode in the longitudinal direction are adhered to each other in a bent state by a binder component of the separator. In the electrode assembly of embodiments of the present invention, the separators at both distal ends in the longitudinal direction are heat-sealed in a downwardly bent state, and thus there is an effect of preventing the separator from being wrinkled when sealing a pouch-type battery case, especially, that of a single cup model.

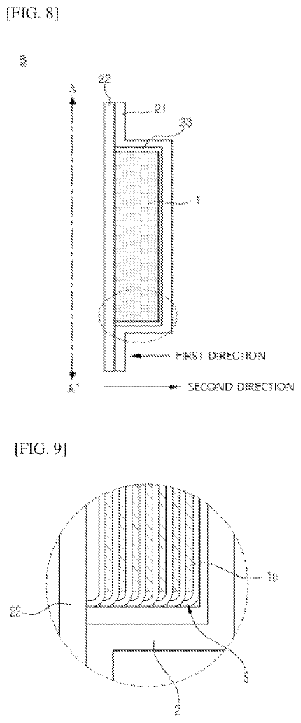

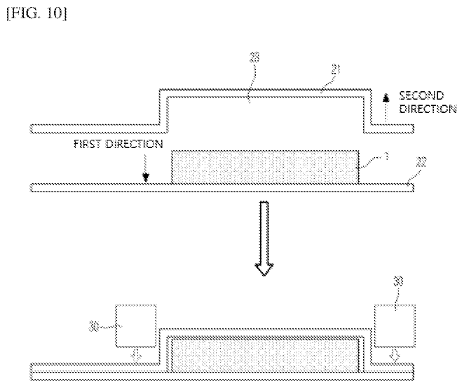

FIG. 7 is a diagram illustrating a pouch-type secondary battery according to an exemplary embodiment of the present invention, FIG. 8 is a cross-sectional view taken along line A-A′ of FIG. 7, FIG. 9 is an enlarged view of a part of FIG. 8, and FIG. 10 is a diagram showing a process of accommodating an electrode assembly in a battery case and sealing the battery case during the manufacturing process of a pouch-type secondary battery according to an exemplary embodiment of the present invention.

Referring to these diagrams, a pouch-type secondary battery B according to an exemplary embodiment of the present invention includes an electrode assembly 1 and a pouch-type battery case 2 accommodating the electrode assembly therein, and the electrode assembly 1 is sealed by sealing the outer periphery of the accommodating part 23 using a sealing member 30 while being accommodated in the accommodating part 23 of the pouch-type battery case 2.

As described above, the electrode assembly 1 may have a structure in which multiple electrodes 1c and multiple separators S are alternately stacked, and the separators S protruding from the end of the electrode are sealed in a state of being bent in the first direction.

The pouch-type battery case 2 may have a structure in which a lower case 22 and an upper case 21 covering the lower case 22 are integrally formed, and the lower case 22 and the upper case 21 may respectively have a laminate structure in which an inner coating layer, a metal layer, and an outer coating layer are stacked in order.

In either one of the upper case 21 and the lower case 22, an electrode assembly accommodating part 23 having an indented interior is provided for accommodating the electrode assembly, so that a pouch-type secondary battery B can be manufactured by accommodating the electrode assembly 1 in the accommodating part 23, folding by bending the contact surface of the lower case 22 and the upper case 21, and forming a sealing part that heat-seals along the outer periphery of the accommodating part 23 of the electrode assembly using the sealing member 30.

In one specific example, referring to FIG. 10(a), when disposing the electrode assembly on the lower case 22, it is disposed so that the first direction, which is the direction in which the distal end of the separator is bent, faces the bottom of the lower case 22. Thereafter, the sealing process of the battery case is performed after covering the lower case 22 with the upper case 21 so that the electrode assembly 1 is accommodated in the accommodating part 23 provided in the upper case 21. At this time, the accommodating part 23 protrudes on a plan view, and the protruding direction of the accommodating part 23 protrudes in a second direction opposite to the first direction.

Referring to FIG. 10(b), the upper case 21 and the lower case 22 are heat-sealed by heating/pressing the area to be sealed of the outer periphery of the accommodating part 23 using the sealing member 30 to melt each inner coating layer of the upper case 21 and the lower case 22. Since the electrode assembly accommodating part 23 is provided in the upper case 21 protrudes in the second direction, the sealing member 30 heats and presses the area to be sealed along the first direction, and since the heating and pressing direction by the sealing member 30 coincides with the bent direction of the distal end of the separator in the electrode assembly, wrinkling of the separator may be prevented during the sealing process of the battery case.

1. An electrode assembly manufacturing device, comprising:
a transfer unit configured to transfer an electrode assembly to a sealing position, wherein the electrode assembly has a plurality of electrodes and a plurality of separators alternately stacked therein;
a plurality of sealing blocks configured to move toward the electrode assembly in the sealing position, and seal both ends of the plurality of separators by heating and pressing; and
a pair of lower supports located below both distal ends of the electrode assembly in a longitudinal direction of the electrode assembly, wherein the pair of lower supports is configured to support both distal ends of the electrode assembly in the longitudinal direction by moving up, so as to allow the plurality of sealing blocks to seal the plurality of separators; and
a control unit configured to control an operation of the transfer unit, the plurality of sealing blocks, and the pair of lower supports,
wherein the control unit is configured to control the pair of lower supports to be moved up in a first state in which the plurality of sealing blocks are moved toward the electrode assembly, and
wherein the pair of lower supports is configured to move up, so as to bend both distal ends of the plurality of separators in a downward direction,
wherein both distal ends of the plurality of separators are configured to be sealed while contacting the plurality of sealing blocks.

2. The electrode assembly manufacturing device of claim 1, wherein
the first state is a state in which the plurality of sealing blocks are configured to move toward the electrode assembly,
wherein a distance between a first plurality of sealing blocks disposed on one side of the electrode assembly in the longitudinal direction and a second plurality of sealing blocks located on the other side of the electrode assembly in the longitudinal direction is smaller than a length of the plurality of separators in the longitudinal direction and the distance between the first and the second of the plurality of sealing blocks is greater than a length of the plurality of electrodes in the longitudinal direction.

3. The electrode assembly manufacturing device of claim 1, wherein
the transfer unit comprises a conveyor on which the electrode assembly is configured to be disposed, and
wherein the conveyor is configured to transfer the electrode assembly, the electrode assembly being disposed such that the longitudinal direction of the electrode assembly is transverse to a transferring direction of the conveyor.

4. The electrode assembly manufacturing device of claim 3, wherein
a width of the conveyor is smaller than a length of the electrode assembly in the longitudinal direction, so that the electrode assembly disposed on the conveyor is configured to bend along the longitudinal direction, such that both distal ends of the electrode assembly in the longitudinal direction are disposed in the downward direction below a height of a contact surface between the conveyor and the electrode assembly.

5. The electrode assembly manufacturing device of claim 1, wherein
each of the plurality of sealing blocks has an “L” shape conforming to a shape of a corner part of the electrode assembly.

6. The electrode assembly manufacturing device of claim 5, wherein
each of the plurality of sealing blocks has a curved surface shape configured to contact the corner part of the electrode assembly.

7. The electrode assembly manufacturing device of claim 1, wherein
the plurality of sealing blocks include at least four sealing blocks.

8. The electrode assembly manufacturing device of claim 1,
further comprising:
a pair of alignment blocks configured to align the electrode assembly,
wherein each of the pair of alignment blocks is disposed on the transfer unit and is spaced apart from each other by a space,
wherein the space corresponds to a width of the electrode assembly, and
wherein the electrode assembly is configured to be placed within the space between each of the pair of alignment blocks.

9. The electrode assembly manufacturing device of claim 8, wherein
each of the pair of alignment blocks has a bar shape and extends along the longitudinal direction of the electrode assembly.

10. An electrode assembly manufacturing method, comprising:
(a) transferring an electrode assembly to a sealing position, wherein the electrode assembly has a plurality of electrodes and a plurality of separators alternately stacked therein;
(b) moving a plurality of sealing blocks located on one side of the electrode assembly in a longitudinal direction and a plurality of sealing blocks located on the other side of the electrode assembly in the longitudinal direction toward the electrode assembly to a predetermined distance between the plurality of sealing blocks on one side of the electrode assembly and the plurality of sealing blocks on the other side of the electrode assembly;
(c) raising both distal ends of the electrode assembly disposed in the longitudinal direction of the electrode assembly by a pair of lower supports that move up toward the electrode assembly,
(d) bending the plurality of separators disposed at both distal ends in a downward direction, wherein the downward direction is opposite to a stacking direction of the electrode assembly; and
(e) sealing the plurality of separators while contacting the plurality of sealing blocks.

11. The electrode assembly manufacturing method of claim 10, wherein
the predetermined distance is smaller than a length of the plurality of separators in the longitudinal direction and greater than a length of the plurality of electrodes in the longitudinal direction.

12. The electrode assembly manufacturing method of claim 10, wherein
in transferring the electrode assembly to the sealing position, the electrode assembly is transferred to the sealing position while being disposed on a conveyor.

13. electrode assembly manufacturing method of claim 10, wherein
in raising both distal ends of the electrode assembly, the pair of lower supports is moved up in a state in which the plurality of sealing blocks move toward the electrode assembly to the predetermined distance.

14. The electrode assembly manufacturing method of claim 10, wherein
in sealing the plurality of separators, the plurality of sealing blocks heat the plurality of separators in contact with the plurality of sealing blocks to a predetermined temperature so that a binder component of the plurality of separators is melted, thereby forming an adhesive strength.

15. The electrode assembly manufacturing method of claim 10,
further comprising:
aligning the electrode assembly between transferring the electrode assembly to the sealing position and moving the plurality of sealing blocks toward the electrode assembly.

16. The electrode assembly manufacturing method of claim 10, further comprising:
returning the plurality of sealing blocks to their original positions;
lowering the pair of lower supports to an initial position; and
taking the electrode assembly sealed with the plurality of separators out from the scaling position.

17. An electrode assembly in which a plurality of electrodes and a plurality of separators are alternately stacked, wherein the plurality of separators protruding from both distal ends of the plurality of electrodes in a longitudinal direction are bent in a downward direction; wherein the downward direction is opposite to a stacking direction of the electrode assembly.

18. A pouch-type secondary battery comprising:
a pouch-type battery case having an accommodating part; and
the electrode assembly of claim 17 disposed in the accommodating part of the pouch-type battery case,
wherein the accommodating part of the pouch-type battery case protrudes in a direction opposite to the downward direction.
